(19) United States
(12) Patent Application Publication
(10) Pub. No.: US 2026/0067723 A1
(43) Pub. Date: Mar. 5, 2026

(54) WIRELESS NETWORK CONNECTION ANALYSIS TECHNIQUES, DEVICES, AND SYSTEMS

(71) Applicant: Ekahau, Inc., New York, NY (US)

(72) Inventors: Olli Alanen, Helsinki (FI); Teemu Pulkkinen, Helsinki (FI); Janne Kurjenniemi, Jyväskylä (FI); Ari Tourunen, Helsinki (FI)

(73) Assignee: Ekahau, Inc., New York, NY (US)

(21) Appl. No.: 18/820,056

(22) Filed: Aug. 29, 2024

(51) Int. Cl. H04W 24/08; H04W 64/00

(52) U.S. Cl. CPC H04W 24/08; H04W 64/00

(57) ABSTRACT

The devices, systems, and methods described herein are directed to utilizing the proximity of one or more nodes of a wireless network to a particular location to identify nodes that are candidates for analysis. In some examples, the devices, systems, and methods may also be used to follow a selected node as it moves and changes channels or access points when roaming.

### FIELD

The subject matter described herein relates to devices, systems, and methods for analyzing wireless network connections and more particularly to identifying devices for analysis based on proximity.

### BACKGROUND

Wi-Fi is a family of wireless network protocols based on the Institute of Electrical and Electronics Engineers (IEEE) 802.11 family of standards, which are commonly used for local area networking of devices and Internet access, allowing nearby digital devices to exchange data via radio waves. Wi-Fi networks are some of the most widely used computer networks in the world, used globally in home and small office networks to link devices together and to connect them to the Internet via a wireless router. Wi-Fi networks often use wireless access points in public places like coffee shops, hotels, libraries, and airports to provide visitors with Internet connectivity for their mobile devices.

### SUMMARY

The devices, systems, and methods described herein are directed to utilizing the proximity of one or more nodes of a wireless network to a particular location to identify nodes that are candidates for analysis. In some examples, the devices, systems, and methods may also be used to follow a selected node as it moves and changes channels or access points when roaming.

### BRIEF DESCRIPTION OF THE DRAWINGS

FIG. 1 is a block diagram of a first example of a system for analyzing connections in a wireless network. The system includes a measurement device and a computing device to perform the analysis.

FIG. 2 is a block diagram of an example of the measurement device shown in FIG. 1.

FIG. 3 is a block diagram of a second example of a system for analyzing connections in a wireless network in which the measurement device is integrated into the computing device.

FIG. 4 is a flow chart of an example of a method for dynamically updating a list of candidate channels to which a device may roam.

FIG. 5 is a flow chart of an example of a method for identifying a node for analysis based on proximity of the node to a first location.

### DETAILED DESCRIPTION

Since Wi-Fi networks are very widely deployed in different environments, one of the most important use cases is the analysis of the performance and capacity of the existing networks. In the context of optimizing a Wi-Fi network, it often makes sense to monitor the traffic between a specific problematic client device and an access point (AP) to which the client device is connected to observe and identify the problem in the communication. In practice, monitoring a particular connection involves using an external device to capture Wi-Fi transmissions being sent from or to a specific client device.

However, identifying a specific client device may be challenging when a large number of client devices are all transmitting at the same time. Also, the relevant Wi-Fi channel being used by the client device might be unknown, and over time, this channel may change depending on the AP to which the client device is connected. Moreover, the number of potential client devices that may be using a particular channel might be large, making it even more difficult to identify one client device from another.

Existing Wi-Fi troubleshooting tools typically define a hierarchy. At the top level of the hierarchy are networks or Service Set Identifiers (SSIDs). An SSID is a identifying name assigned to a Wi-Fi network. On the second level of the hierarchy are the AP radios belonging to that network. The third level of the hierarchy are the clients that are associated with the AP radios. Navigating through this hierarchy is one commonly used way to find and identify clients.

Other means for identifying clients include searching for a Media Access Control (MAC) address, an Internet Protocol (IP) address, or a hostname. However, in all of these cases, it is still difficult to properly distinguish which identifier actually corresponds with a particular device. Thus, conventional solutions for identifying a particular client device for Wi-Fi troubleshooting or optimization are cumbersome, time-consuming, and error-prone.

The devices, systems, and methods described herein are directed to utilizing the proximity of one or more nodes of a wireless network to a particular location to identify nodes that are candidates for analysis. In some examples, the devices, systems, and methods may also be used to follow a selected node as it moves and changes channels or access points when roaming.

Many of the following examples are directed to performing an analysis of connections between nodes of a wireless network. As used herein, a “connection analysis” refers to an analysis meant to evaluate a connection between nodes of the wireless network. As used herein, an “optimization analysis” refers to an analysis to evaluate a connection between nodes and, if appropriate, the generation of one or more recommendations to optimize the connection. A “troubleshooting procedure,” as used herein, refers to a procedure by which a node having connectivity problems is evaluated and recommendations are made to improve connectivity for the node. As used herein, an “optimization analysis” and a “troubleshooting procedure” are both considered to be types of “connection analysis. ” Thus, the devices, systems, and methods set forth herein may be utilized to perform various types of connection analyses, including an optimization analysis and/or a troubleshooting procedure. In this regard, any reference to a particular type of analysis or procedure is not intended to be limited to that particular analysis or procedure. Rather, it should be understood that any other suitable connection analysis or procedure may be performed in place of a particularly specified analysis or procedure in the following description.

Although the different examples of devices, systems, and methods may be described herein separately, any of the features of any of the examples may be added to, omitted from, or combined with any other example. Similarly, any of the features of any of the examples may be performed in parallel or performed in a different manner/order than that described or shown herein.

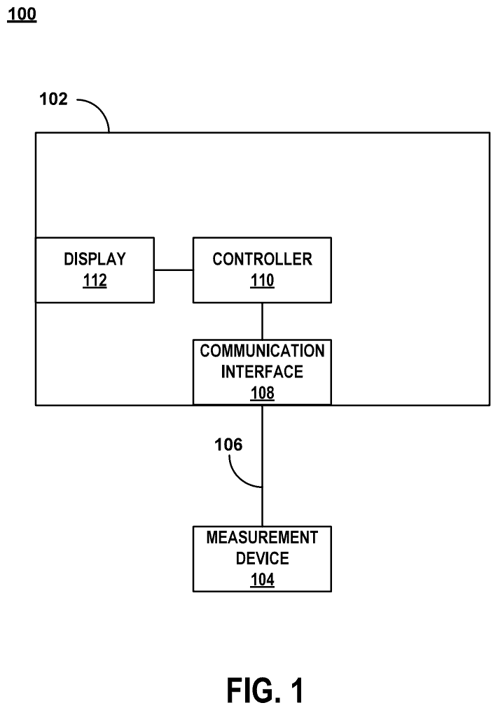

FIG. 1 is a block diagram of a first example of a wireless network optimization system including a measurement device and a computing device to perform an optimization analysis. In the example shown in FIG. 1, wireless network optimization system 100 includes local computing device 102 and measurement device 104. In some examples, local computing device 102 can be any on-site computing device that can receive and process data associated with a wireless network. For example, local computing device 102 could be a tablet computer, a laptop computer, a smartphone, or a desktop computer. In other examples, any other suitable computing device, even a remote, off-site computing device, could be used to perform the functions described herein.

Local computing device 102 includes communication interface 108, controller 110, and display 112. In operation, local computing device 102 receives data from measurement device 104 via communication link 106. Communication interface 108 enables communication between measurement device 104 and local computing device 102. In the example shown in FIG. 1, communication link 106 is a wired communication link that operates in accordance with at least one of the family of Universal Serial Bus (USB) specifications. In other examples, communication link 106 may operate in accordance with other wired specifications. In further examples, communication link 106 may operate in accordance with any suitable wireless specification (e.g., Bluetooth).

Controller 110 includes any combination of hardware, software, and/or firmware for executing the functions described herein. An example of a suitable controller 110 includes software code running on a microprocessor or processor arrangement connected to memory (not explicitly shown).

Display 112 is used to display, to a user, information pertaining to the quality of the connections of the wireless network detected by measurement device 104 at a particular location. In this manner, the user can easily see the current status and quality of the connections in order to select one or more nodes for which an optimization analysis and/or troubleshooting procedure should be performed. In some examples, display 112 includes an associated input mechanism (e.g., touchscreen, keyboard, microphone, etc.) by which the user can select one or more nodes for an optimization analysis or troubleshooting procedure.

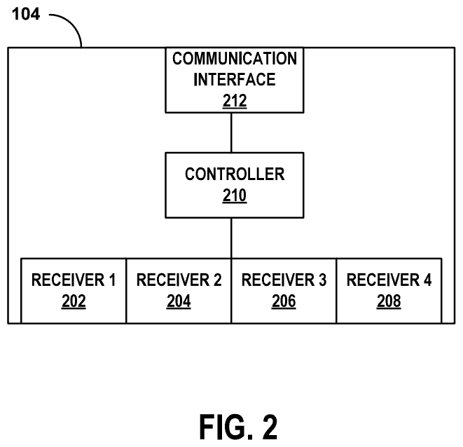

FIG. 2 is a block diagram of an example of measurement device 104 shown in FIG. 1. In the example shown in FIG. 2, measurement device 104 utilizes four receivers (e.g., receiver 1, 202; receiver 2, 204; receiver 3, 206; receiver 4, 208) to receive Wi-Fi signals from various nodes of a wireless network. In other examples, any other suitable number of receivers may be utilized in measurement device 104. Regardless of the number of receivers in measurement device 104, each receiver is capable of scanning and monitoring a set of Wi-Fi channels and capturing all Wi-Fi link layer frames (e.g., packets) being heard on those channels, in some examples. In other examples, a single Wi-Fi radio (e.g., receiver), module, or chipset can be configured to operate on the separate channels at the same time, which is referred to as a Dual Band Simultaneous (DBS) configuration. Thus, the functionality of the measurement device, as described herein, may be accomplished with a measurement device having multiple receivers or a single, properly configured receiver.

The measurement device 104 shown in FIG. 2 also includes controller 210, which processes the signals received by receivers 202, 204, 206, and 208. Controller 210 includes any combination of hardware, software, and/or firmware for executing the functions described herein. An example of a suitable controller 210 includes software code running on a microprocessor or processor arrangement connected to memory (not explicitly shown). It is worth noting that, in some examples, any of the functions described herein as being performed by controller 110 may be performed by controller 210, and vice versa.

Measurement device 104, as shown in FIG. 2, also includes communication interface 212, which measurement device 104 uses to communicate with local computing device 102 via communication link 106. In some examples, the communication between measurement device 104 and local computing device 102 includes providing data to local computing device 102 and receiving command instructions regarding which node or nodes of a wireless network are selected for optimization analysis. As will be discussed more fully below, based on which node or nodes are selected for optimization analysis, controller 210 can dynamically configure receivers 202, 204, 206, and 208 to monitor particular channels during the optimization analysis, in some examples.

In further examples, measurement device 104 may be any fixed, mobile, or portable equipment that performs the functions described herein. The various functions and operations described with reference to measurement device 104 may be implemented in any number of devices, circuits, or elements. Two or more of the functions of the measurement device may be integrated in a single device, and the functions described as performed in any single measurement device may be implemented over several measurement devices. In the interest of brevity, FIG. 1 only depicts one measurement device 104. However, any number of measurement devices may be utilized to receive Wi-Fi signals, in other examples.

In operation, a user places measurement device 104 in a location that is proximal to one or more nodes of a wireless network that may be candidates for an optimization analysis or troubleshooting procedure. As used herein, a “node of a wireless network” can be used to describe any device that is capable of sending or receiving data to and from other nodes of the wireless network. In some examples, a “node” may be an end device, also referred to herein as a client device, that serves as a source point or a destination point in the communication that occurs on the wireless network. Examples of an end device include a laptop or desktop computer, a work station, a tablet, a mobile phone, a printer, a scanner, or a server, etc. In other examples, a “node” may be an intermediary device that is designed to forward data between other devices in the wireless network. Examples of an intermediary device include wireless access points, routers, or repeaters, etc.

One or more of the receivers 202, 204, 206, 208 of measurement device 104 receive wireless signals transmitted from one or more nodes of a wireless network. For example, the received signals may be transmitted by one or more client devices and/or one or more access points of the wireless network. In some examples, one or more of receivers 202, 204, 206, 208 scan the potential channels of the wireless network to find nearby access points of the wireless network. Once the access points have been identified, the receivers can focus on scanning the channels that the nearby access points are using. The other channels should still be measured in the background, but the sampling frequency of the other channels can be much lower than the channels utilized by the nearby access points.

Measurement device 104 decodes the received wireless signals and provides data obtained from the decoded signals to controller 110. Based on the data obtained from the decoded wireless signals, controller 110 identifies at least one node that (1) is proximal to the location of measurement device 104, and (2) is a candidate for optimization analysis and/or a troubleshooting procedure. In some examples, the node may be near (e.g., proximal to) the location of measurement device 104. In other examples, the node may be adjacent to the location of measurement device 104. In further examples, the node may be in physical contact with measurement device 104.

In some examples, controller 210 identifies that a node is proximal to measurement device 104 when a minimum number of packets are received in wireless signals from the node having a received signal strength indicator (RSSI) that exceeds a signal strength threshold value. For example, when attempting to detect and identify the nodes of the wireless network, the receivers 202, 204, 206, 208 of measurement device 104 receive wireless signals, and measurement device 104 sorts the received signals based on their respective RSSIs to determine which nodes are proximal to measurement device 104.

In some examples, a static signal strength threshold value may be used to determine which nodes are proximal to measurement device 104. In one particular example, assuming that a signal strength threshold value of −35 dBm is used, a node is determined to be proximal to measurement device 104 if the mean RSSI of 10 consecutive packets received from that node is equal to or greater than the signal strength threshold value of −35 dBm. In other examples, any other suitable signal strength threshold value may be used. Similarly, any other suitable number of consecutive packets over which the mean RSSI is measured may be used, in other examples. In further examples, different signal strength threshold values may be utilized for different node types. In still further examples, a lower signal strength threshold value may be used for nodes that may be experiencing connectivity problems, making them candidates for troubleshooting analysis, and a higher signal strength threshold value may be used when trying to identify nodes that are candidates for optimization analysis.

In other examples, controller 210 identifies that a node is proximal to measurement device 104 based on one or more radio-frequency identification (RFID) signals received from the node. In further examples, controller 210 can identify that a node is proximal to measurement device 104 based on any other suitable wireless signals received from the node (e.g., Bluetooth, near-field communication (NFC), etc.).

Thus, in some examples, wireless network optimization system 100 utilizes the proximity of the node to measurement device 104 as a detection mechanism for identifying the node as a candidate for optimization analysis and/or a troubleshooting procedure.

In some examples, when one or more nearby nodes are detected and identified, a list of the identified nodes is displayed to a user on display 112. In further examples, the list of identified nodes may also provide information to the user regarding the quality of the connection associated with each node. In some examples where the node is a client device, the list of identified nodes may include information regarding the connectivity of that particular client device, which may include the access point to which the client device is connected, the RSSI of the signal received from the access point, the channel being utilized for the connection, measured connectivity speeds, data rates, interference information, etc. Of course, any other suitable signal characteristics may be measured and included in the list of identified nodes. For example, the signal characteristic measurement values may include other measurements of signal strength and/or quality. Any additional information may be included in the list of identified nodes to facilitate selection of a node for optimization analysis and/or a troubleshooting procedure by the user.

In some examples, the list of identified nodes includes all detected nearby nodes. In other examples, only nodes with a connectivity problem that meets a minimum threshold value may be included in the list of identified nodes. In further examples, the list of identified nodes can be sorted such that nodes with the worst connectivity are listed first so that the user can see which devices may benefit the most from an optimization analysis or a troubleshooting procedure.

Using display 112 or an associated input mechanism (e.g., touchscreen, keyboard, microphone, etc.), the user selects, from the list of identified nodes, one or more nodes for an optimization analysis or troubleshooting procedure. In response to the user selecting one or more of the identified nodes from the list, the controller 110 analyzes the connection between the selected node(s) and the wireless network, in some examples. In this manner, the wireless network optimization system 100 performs an optimization analysis (or a troubleshooting procedure) of a connection between at least one of the identified nodes and the wireless network. In other examples, system 100 may be configured to automatically perform an optimization analysis or a troubleshooting procedure on nodes identified by controller 110 as having connectivity problems.

In some examples, once the user selects one or more nodes, one of the receivers 202, 204, 206, 208 is dedicated to the channel that the selected node is currently using so that more accurate and detailed information can be received and analyzed. In these examples, display 112 can be updated with details on the selected node's connectivity and quality of the connection, which may include connection establishment phases, connection success status, and connectivity delays. In addition, quality metrics such as radio frequency (RF) metrics, retransmission rate, data-rate, throughput, airtime utilization, etc. may be shown, in further examples.

In still further examples, controller 110 analyzes the connectivity problems and generates one or more recommendations to improve the quality of the connection between at least one of the identified nodes and the wireless network. In these examples, display 112 can present the recommendations to the user to improve the connectivity of the selected node.

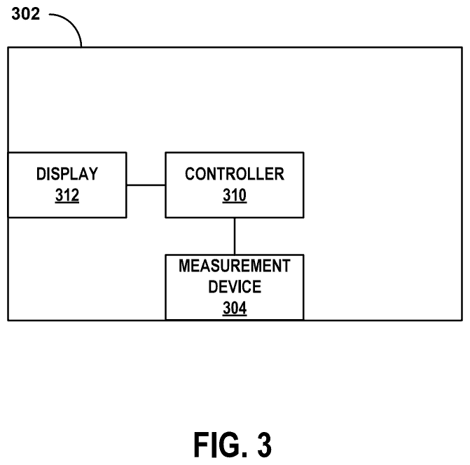

FIG. 3 is a block diagram of a second example of a wireless network optimization system in which the measurement device is integrated into the local computing device. In the example shown in FIG. 3, wireless network optimization system 302 includes measurement device 304, controller 310, and display 312. In the example shown in FIG. 3, controller 310 is capable of performing the combined functions of controller 110 and controller 210, as described in connection with FIGS. 1 and 2. Thus, wireless network optimization system 302 performs the combined functions of measurement device 104 and local computing device 102, as described herein.

Regardless of whether the measurement device is in communication with or is integrated into the local computing device, once the selected node is being analyzed for optimization and/or troubleshooting, the scanning logic of receivers 202, 204, 206, 208 can be updated to follow the selected node when it roams, in some examples. For example, a roaming client device may change channels as it moves and/or switch the access point with which the client device is associated. In these examples, measurement device 104 would be kept proximal to, adjacent to, or in physical contact with the client device as the client device moves. Keeping measurement device 104 near the moving client device enables measurement device 104 to obtain signal measurements that correspond to the signals being received by the client device.

In some examples, receivers 202, 204, 206, 208 are each configured to receive wireless signals on different channels, wherein one receiver is dedicated to monitoring a channel used by the node that has been selected/identified for an optimization analysis or a troubleshooting procedure. As used herein, “monitoring” the channel may include analyzing (e.g., receiving, decoding, and interpreting) the signals on the channel, in some examples. In other examples, “monitoring” may include scanning the channel and taking measurements of channel characteristics.

In further examples, at least one other receiver is dedicated to monitoring at least one candidate channel that is available for the selected/identified node to roam. In still further examples, at least one other receiver is dedicated to monitoring at least one candidate channel used by another access point that is available for the selected/identified node to roam. In these examples, the other access point may be an access point associated with the wireless network to which the selected/identified node is currently connected. In other examples, the other access point may be an access point associated with a second, different wireless network. For example, multiple wireless networks, each having one or more access points, may be operated in close proximity to each other in shopping malls, or the like, and it may be advantageous for the operators of the wireless networks to allow patrons walking through the shopping mall to easily roam from one network to the next without connectivity interruptions.

Thus, in operation, when the selected node is being analyzed for optimization and/or troubleshooting, one of the receivers (e.g., receiver 202) is dedicated to the channel that the selected node is currently using, and one or more of the other receivers (e.g., receiver 204, 206) may be used to scan other channels to which the client device could potentially roam (e.g., switch), in some examples. In other examples, one or more of the other receivers (e.g., receiver 208) may be used to scan other nearby access points to which the client device may connect. The algorithm used to determine how many receivers to use to scan other channels or access points can be dynamically adjusted based on various factors. In some examples, RSSI measurements can be used to switch the scanning logic to prioritize more likely roaming candidates.

For example, if the client device is not moving, measurement device 104 will not be moving either. Although not explicitly shown in the figures, acceleration sensors in measurement device 104 can be used to detect movement of measurement device 104 as measurement device 104 “follows” the client device as the client device is moving. In the examples in which measurement device 104 does not detect movement, the algorithm that controls the scanning logic can be dynamically adjusted to prioritize roaming candidates in the current location of the client device and measurement device 104. In some of these examples, a higher priority may be placed on using a greater number of receivers to scan for channels to which the client device may roam. For example, two receivers could be utilized to scan other channels to which the client device could potentially roam (e.g., switch) while only one other receiver could be utilized to scan other nearby access points to which the client device may connect.

In the examples in which measurement device 104 detects movement associated with following a moving client device, the algorithm that controls the scanning logic can be dynamically adjusted to prioritize more likely roaming candidates as the client device and measurement device 104 move. In some of these examples, a higher priority may be placed on using a greater number of receivers to scan for access points to which the client device may roam (e.g., switch). For example, two receivers could be utilized to scan other nearby access points to which the client device may connect while only one other receiver could be utilized to scan other channels to which the client device could potentially roam.

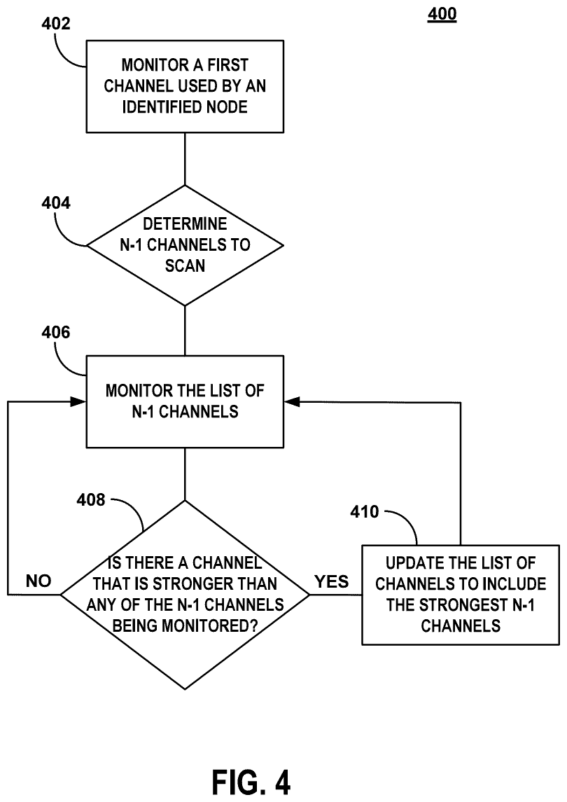

FIG. 4 is a flow chart of an example of a method for dynamically updating a list of candidate channels to which a device may roam. In the example shown in FIG. 4, the controller of the measurement device performs the steps of the method 400. In other examples, a controller of a local computing device to which the measurement device is connected may perform the steps of method 400.

Method 400 begins at step 402 with monitoring a first channel used by an identified/selected node. At step 404, one or more of the N receivers of the measurement device are used to determine a list of N−1 candidate channels in use by the N−1 strongest access points or radios of the current network having the highest received signal strength indicator (RSSI) values in the current location of the measurement device. Once the N−1 channels are determined, one of the receivers of the measurement device maintains the list of N−1 channels and dynamically updates the list of candidate channels when another channel, in use by the current network, has a stronger RSSI value at the location of the measurement device than at least one of the candidate channels currently on the list of candidate channels.

For example, at step 406, while the one receiver maintains the list of N−1 channels, the remaining N−1 receivers of the measurement device monitor the channels included in the list of N−1 channels. In some examples, monitoring the channels includes capturing packet traffic on the N−1 channels. At step 408, the controller of the measurement device determines if there is a channel that is stronger than any of the N−1 channels being monitored. If not, the method continues at step 406, with monitoring the channels on the list of N−1 channels. If so, the method proceeds to step 410, and the controller of the measurement device updates the list of channels to include the strongest N−1 channels. After updating the list of channels, the method continues at step 406, where at least one of the receivers monitors wireless signals transmitted on the updated list of N−1 candidate channels.

In the example shown in FIG. 4, the list of candidate channels is updated when it is determined that there is a channel that is stronger than any of the N−1 channels being monitored. In other examples, the list of candidate channels is updated periodically.

As used herein, the “current network” refers to a users' internal network with known network identifiers, or Service Set Identifiers (SSIDs), and the channels maintained in the list of candidate channels are used by radios that all belong to the same SSID, or set of SSIDs.

In a typical wireless network it is inadvisable for two radios to occupy the same channel, if at all avoidable, meaning for the N−1 strongest radios there will most likely be N−1 channels in the list. It is nevertheless possible that the number of channels is less than the number of radios (e.g. N−1 strongest radios use N−2 channels), in which case the algorithm would choose the next strongest radio with a unique channel to ensure that N−1 channels are always being monitored, in some examples.

The above description is directed to optimizing or troubleshooting issues in the user's own network. However, in other examples, issues in transitioning between networks could be analyzed by forgoing the need to monitor a specific network (e.g. when transitioning from one business to another in a shopping mall), in which case the list of channels simply contains the channels used by the N−1 strongest radios, regardless of network identifiers.

In a dense network, and/or one with highly isolated coverage (so that the transition from one network to the next could be relatively abrupt), maintaining N−1 strongest radios and/or channels might not be enough to compensate for a quickly moving client or a network configuration with high variance. For example, consider a shopping mall with highly attenuating walls between businesses. In such an environment, the neighboring radios (of the neighboring businesses) might not actually be heard before the user exits the business, causing the smart scanning logic to not be prepared for the transition from one radio to the next since the radio being transitioned to is not operating on a channel that is being monitored. In this scenario it might be necessary to devote further receivers to maintain the list of channels, in order to ensure the list is updated quickly enough for rapid transitions. In some examples, the algorithm could transition to a setup where one receiver records packet traffic from the strongest channel, and N−1 receivers scan for the strongest radio among all available channels, regardless of the network identifiers.

The above “adaptive smart scanning logic” could either be provided to the user as an option, based on their best understanding of the network characteristics, or it might be a part of the smart scanning logic itself. For instance, signal strength thresholds might indicate whether or not the candidate for transition is among the maintained list of radios. Best practice wireless design requirements for WiFi, for instance, might indicate that at any time the client device needs to be aware of at least two radios at −67 dBm (or, for instance, a “primary” radio at −67 dBm and a “secondary” radio at −70 dBm). These best practices could be applied in choosing the distribution of receivers for different tasks. For instance, if no radios provide the minimum signal strength for the “primary” signal requirement, N−1 adapters could be devoted to scanning channels until the requirement is fulfilled. If only a “primary” radio is available but a “secondary” radio is not, N−2 adapters could be devoted to scanning channels, and so on.

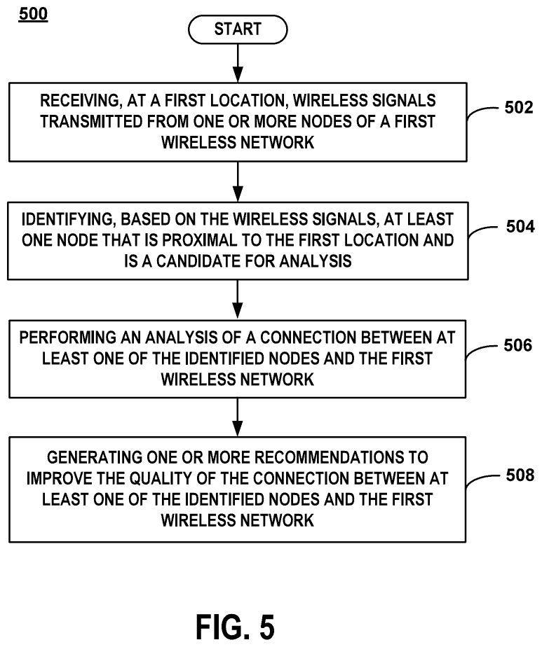

FIG. 5 is a flow chart of an example of a method for identifying a node for optimization analysis based on proximity of the node to a first location. The method 500 begins at step 502 with receiving, at a first location, wireless signals transmitted from one or more nodes of a wireless network. At step 504, the method continues with identifying, based on the wireless signals, at least one node that is proximal to the first location and is a candidate for optimization analysis. At step 506, the method further includes performing an optimization analysis of a connection between at least one of the identified nodes and the wireless network. At step 508, the method also includes generating one or more recommendations to improve the quality of the connection between at least one of the identified nodes and the wireless network. In other examples, one or more of the steps of method 500 may be omitted, combined, performed in parallel, or performed in a different order than that described herein or shown in FIG. 5. In still further examples, additional steps may be added to method 500 that are not explicitly described in connection with the example shown in FIG. 5.

Clearly, other examples and modifications of the foregoing will occur readily to those of ordinary skill in the art in view of these teachings. The above description is illustrative and not restrictive. The examples described herein are only to be limited by the following claims, which include all such examples and modifications when viewed in conjunction with the above specification and accompanying drawings. The scope of the foregoing should, therefore, be determined not with reference to the above description alone, but instead should be determined with reference to the appended claims along with their full scope of equivalents.

What is claimed is:

1. A system for analyzing connections in a wireless network, the system comprising:
a receiver to receive, at a first location, wireless signals transmitted from one or more nodes of a first wireless network; and
a controller to:
identify, based on the wireless signals, at least one node that is proximal to the first location and is a candidate for analysis, and
perform an analysis of a connection between at least one of the identified nodes and the first wireless network.

2. The system of claim 1, wherein the one or more nodes of the first wireless network are client devices.

3. The system of claim 1, wherein the one or more nodes of the first wireless network are access points.

4. The system of claim 1, wherein the controller identifies that the at least one node is proximal to the first location when a minimum number of packets are received in wireless signals from the at least one node having a received signal strength indicator (RSSI) that exceeds a first signal strength threshold value.

5. The system of claim 1, wherein the controller identifies that the at least one node is proximal to the first location based on one or more radio-frequency identification (RFID) signals received from the at least one node.

6. The system of claim 1, further comprising a display to display, to a user, a list of the identified nodes, wherein the controller analyzes the connection between at least one of the identified nodes and the first wireless network, in response to the user selecting one or more of the identified nodes from the list for the analysis.

7. The system of claim 1, wherein the receiver comprises a plurality of receivers, each of the plurality of receivers to receive wireless signals on different channels, wherein a first receiver of the plurality of receivers is dedicated to monitoring a first channel used by one of the identified nodes for which the analysis is being performed.

8. The system of claim 7, wherein at least one other receiver of the plurality of receivers is dedicated to monitoring at least one candidate channel that is available for the identified nodes to roam.

9. The system of claim 8, wherein at least one other receiver of the plurality of receivers is dedicated to monitoring at least one candidate channel used by another access point that is available for the identified nodes to roam.

10. The system of claim 9, wherein the another access point is an access point associated with the first wireless network.

11. The system of claim 9, wherein the another access point is an access point associated with a second wireless network.

12. The system of claim 7, wherein the controller:
maintains a list of candidate channels that are being used by access points of the first wireless network having the highest received signal strength indicator (RSSI) values at the first location; and
dynamically updates the list of candidate channels when another channel, in use by the first wireless network, has a stronger RSSI value at the first location than at least one of the candidate channels currently on the list of candidate channels,
wherein at least one of the plurality of receivers monitors wireless signals transmitted on the updated list of candidate channels.

13. The system of claim 1, wherein the controller further generates one or more recommendations to improve the quality of the connection between at least one of the identified nodes and the first wireless network.

14. A method for analyzing connections in a wireless network, the method comprising:
receiving, at a first location, wireless signals transmitted from one or more nodes of a first wireless network;
identifying, based on the wireless signals, at least one node that is proximal to the first location and is a candidate for analysis; and
performing an analysis of a connection between at least one of the identified nodes and the first wireless network.

15. The method of claim 14, wherein the one or more nodes of the first wireless network are client devices.

16. The method of claim 14, wherein the one or more nodes of the first wireless network are access points.

17. The method of claim 14, wherein identifying that the at least one node is proximal to the first location is based on receiving a minimum number of packets in wireless signals from the at least one node having a received signal strength indicator (RSSI) that exceeds a first signal strength threshold value.

18. The method of claim 14, wherein identifying that the at least one node is proximal to the first location is based on one or more radio-frequency identification (RFID) signals received from the at least one node.

19. The method of claim 14, further comprising:
displaying, to a user, a list of the identified nodes; and
analyzing the connection between at least one of the identified nodes and the first wireless network, in response to the user selecting one or more of the identified nodes from the list for the analysis.

20. The method of claim 14, wherein receiving the wireless signals transmitted from one or more nodes includes receiving the wireless signals with a plurality of receivers, each of the plurality of receivers to receive wireless signals on different channels, wherein a first receiver of the plurality of receivers is dedicated to monitoring a first channel used by one of the identified nodes for which the analysis is being performed.

21. The method of claim 20, wherein at least one other receiver of the plurality of receivers is dedicated to monitoring at least one candidate channel that is available for the identified nodes to roam.

22. The method of claim 21, wherein at least one other receiver of the plurality of receivers is dedicated to monitoring at least one candidate channel used by another access point that is available for the identified nodes to roam.

23. The method of claim 22, wherein the another access point is an access point associated with the first wireless network.

24. The method of claim 22, wherein the another access point is an access point associated with a second wireless network.

25. The method of claim 20, wherein further comprising:
maintaining a list of candidate channels that are being used by access points of the first wireless network having the highest received signal strength indicator (RSSI) values at the first location; and
dynamically updating the list of candidate channels when another channel, in use by the first network, has a stronger RSSI value at the first location than at least one of the candidate channels currently on the list of candidate channels,
wherein at least one of the plurality of receivers monitors wireless signals transmitted on the updated list of candidate channels.

26. The method of claim 14, further comprising:
generating one or more recommendations to improve the quality of the connection between at least one of the identified nodes and the first wireless network.
